(19) United States
(12) Patent Application Publication
(10) Pub. No.: US 2026/0204558 A1
(43) Pub. Date: Jul. 16, 2026

(54) METHOD FOR MANUFACTURING POSITIVE ELECTRODE ACTIVE MATERIAL FOR SECONDARY BATTERY

(71) Applicant: Panasonic Energy Co., Ltd., Moriguchi-shi, Osaka (JP)

(72) Inventors: Takaya Tochio, Nara (JP); Kaoru Nagata, Osaka (JP); Takeshi Ogasawara, Hyogo (JP); Katsuya Inoue, Hyogo (JP); Akihiro Kawakita, Hyogo (JP)

(73) Assignee: Panasonic Energy Co., Ltd., Moriguchi-shi, Osaka (JP)

(21) Appl. No.: 19/134,393

(22) PCT Filed: Dec. 26, 2023
(86) PCT No.: PCT/JP2023/046806

§ 371 Date: May 30, 2025

(30) Foreign Application Priority Data
Dec. 28, 2022 (JP) 2022-211581

(51) Int. Cl. H01M 4/525; H01M 4/02

(52) U.S. Cl. CPC H01M 4/525; H01M 2004/021; H01M 2004/028

(57) ABSTRACT

This method for manufacturing a positive electrode active material for a secondary battery comprises a water-wash step for stirring a slurry obtained by mixing an Ni-containing lithium transition metal oxide with water or an aqueous solution and water-washing the Ni-containing lithium transition metal oxide, a solid-liquid separation step for carrying out solid-liquid separation of the slurry to obtain a cake containing the Ni-containing lithium transition metal oxide, a drying step for drying the cake, and an adding step for adding a sulfonic-acid-compound-containing solution to the cake after the drying step, the method being characterized in that the sulfonic acid compound is expressed by general formula (1) (in the formula, A is H, Li, or Na, and R is H or a hydrocarbon group).

### TECHNICAL FIELD

The present disclosure relates to a method for manufacturing a positive electrode active material for a secondary battery.

### BACKGROUND

A lithium transition metal oxide used as a positive electrode active material for a secondary battery preferably contains Ni, for example, from the viewpoint of increasing the battery capacity. However, when the Ni-containing lithium transition metal oxide is used as the positive electrode active material for a secondary battery, the reaction resistance of a positive electrode increases, and the direct current resistance of the battery may increase.

Conventionally, in order to improve battery characteristics such as reduction in direct current resistance of a battery, a technique of attaching a sulfonic acid compound to a particle surface of a lithium transition metal oxide has been known. For example, Patent Literature 1 discloses a positive electrode active material in which a Li salt of an acid having a structure represented by the general formula: X1-R—X2 (in the formula, X1 and X2 are sulfo groups (—SO₃H)) is interspersed on a particle surface of a lithium transition metal oxide.

### CITATION LIST

### Patent Literature

Patent Literature 1: JP 2019-169286 A

### SUMMARY

As described above, a positive electrode active material for a secondary battery in which a sulfonic acid compound is attached to a particle surface of the lithium transition metal oxide has been known, but a method for manufacturing the same has not been established. As a method for attaching the sulfonic acid compound to the particle surface of the lithium transition metal oxide, a method for adding a sulfonic-acid-compound-containing solution to the lithium transition metal oxide is conceivable in consideration of application to a mass production step of the positive electrode active material. However, with a manufacturing method in which the sulfonic-acid-compound-containing solution is simply added to the lithium transition metal oxide, aggregation of secondary particles of a Ni-containing lithium transition metal oxide is promoted, and a positive electrode active material having many coarse particles may be obtained. Therefore, there arises a problem that a sieving loss rate increases when the obtained positive electrode active material is sieved. The sieving loss rate is the ratio of the mass of a positive electrode active material remaining on a sieve with respect to the total mass of the sieved positive electrode active material when the positive electrode active material is separated (classified) between on the sieve and under the sieve.

Therefore, an object of the present disclosure is to provide a method for manufacturing a positive electrode active material for a secondary battery capable of reducing a sieving loss rate of the positive electrode active material in the method for manufacturing a positive electrode active material for a secondary battery in which a sulfonic acid compound is attached to a particle surface of a lithium transition metal oxide.

A method for manufacturing a positive electrode active material for a secondary battery according to one aspect of the present disclosure includes: a water-wash step for stirring a slurry obtained by mixing an Ni-containing lithium transition metal oxide with water or an aqueous solution and water-washing the Ni-containing lithium transition metal oxide: a solid-liquid separation step for carrying out solid-liquid separation of the slurry to obtain a cake containing the Ni-containing lithium transition metal oxide; a drying step for drying the cake; and an adding step for adding a sulfonic-acid-compound-containing solution to the cake after the drying step, the method being characterized in that the sulfonic acid compound is expressed by general formula (I)

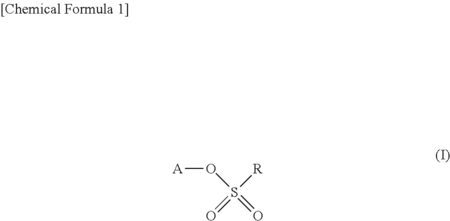

where A is H, Li, or Na, and R is H or a hydrocarbon group.

According to one aspect of the present disclosure, a sieving loss rate of the positive electrode active material can be reduced.

### DESCRIPTION OF EMBODIMENTS

A method for manufacturing a positive electrode active material for a secondary battery according to the present embodiment includes: a water-wash step for stirring a slurry obtained by mixing an Ni-containing lithium transition metal oxide with water or an aqueous solution and water-washing the Ni-containing lithium transition metal oxide; a solid-liquid separation step for carrying out solid-liquid separation of the slurry to obtain a cake containing the Ni-containing lithium transition metal oxide; a drying step for drying the cake; and an adding step for adding a sulfonic-acid-compound-containing solution to the cake after the drying step. Hereinafter, the method for manufacturing a positive electrode active material for a secondary battery according to the present embodiment will be described in detail for each step.

### (Water-Wash Step)

The water-wash step is a step for stirring a slurry obtained by mixing an Ni-containing lithium transition metal oxide with water or an aqueous solution and water-washing the Ni-containing lithium transition metal oxide.

On a particle surface of the Ni-containing lithium transition metal oxide before the water-wash step, a lithium compound (for example, lithium carbonate) or the like used at the time of synthesis sometimes remains in an unreacted state. However, the unreacted lithium compound or the like remaining on the particle surface of the Ni-containing lithium transition metal oxide can be removed by performing the water-wash step. Secondary particles of the Ni-containing lithium transition metal oxide aggregate, for example, via the lithium compound remaining on the particle surface. However, the aggregation of the secondary particles of the Ni-containing lithium transition metal oxide is suppressed in the present embodiment since the lithium compound remaining on the particle surface of the Ni-containing lithium transition metal oxide is removed by the water-wash step.

As the Ni-containing lithium transition metal oxide, one obtained using a known technique can be used. For example, the Ni-containing lithium transition metal oxide can be obtained by mixing a lithium compound with a Ni composite hydroxide obtained by co-precipitating (crystallizing) metal elements other than lithium constituting the Ni-containing lithium transition metal oxide or a Ni composite oxide obtained by further heat-treating the Ni composite hydroxide, and then firing the obtained lithium mixture. The lithium compound is, for example, lithium carbonate, lithium hydroxide, or the like.

The Ni-containing lithium transition metal oxide may contain elements other than Ni and Li. Examples of the other elements include Co, Mn, Al, B, Mg, Ti, V, Cr, Fe, Cu, Zn, Ga, Sr, Zr, Nb, In, Sn, Ta, and W. Examples of the Ni-containing lithium transition metal oxide include oxides represented by the general formula: Li_{b}Ni₁₋ₓMₓO_{2+β} (in the formula, 0≤x≤0.35, 0.95≤b≤1.20, 0≤β≤0.5, and M is at least one element selected from Co, Mn, Al, B, Mg, Ti, V, Cr, Fe, Cu, Zn, Ga, Sr, Zr, Nb, In, Sn, Ta, and W).

Water-washing may be performed by a known method. For example, the Ni-containing lithium transition metal oxide and water or the aqueous solution are introduced into a reaction tank equipped with a stirrer, and then stirred. As the water-wash step progresses, a molar ratio of Li/Ni on the particle surface of the Ni-containing lithium transition metal oxide decreases, but it is preferable to perform the water-wash step until the molar ratio of Li/Ni becomes less than or equal to 1.5. As a result, the lithium compound remaining on the particle surface of the Ni-containing lithium transition metal oxide is sufficiently removed, and the aggregation of secondary particles of the Ni-containing lithium transition metal oxide is further suppressed. In the present embodiment, for example, the slurry during the water-washing may be periodically collected to measure the molar ratio of Li/Ni on the particle surface of the Ni-containing lithium transition metal oxide. Alternatively, an elapsed time of the water-wash step and the molar ratio of Li/Ni on the particle surface of the Ni-containing lithium transition metal oxide may be measured by a preliminary experiment to obtain the time at which the molar ratio of Li/Ni is less than or equal to 1.5 in advance. The molar ratio of Li/Ni on the surface of the Ni-containing lithium transition metal oxide can be measured by X-ray photoelectron spectroscopy (XPS).

In the water-wash step, for example, a slurry concentration of the slurry is preferably greater than or equal to 500 g/L, and more preferably greater than or equal to 500 g/L and less than or equal to 2000 g/L. The slurry concentration (g/L) means the mass (g) of the Ni-containing lithium transition metal oxide mixed with 1 L of water or the aqueous solution. When the slurry concentration is less than 500 g/L, there is a possibility that lithium is excessively washed away from the Ni-containing lithium transition metal oxide, which may affect battery characteristics.

A water-wash temperature is, for example, greater than or equal to 10° C. and less than or equal to 40° C. In addition, a water-wash time is, for example, greater than or equal to 5 minutes and less than or equal to 60 minutes. Although the water or aqueous solution to be used is not particularly limited, from the viewpoint of removing the unreacted lithium compound remaining on the particle surface of the Ni-containing lithium transition metal oxide having an electrical conductivity of, for example, water with a measured electrical conductivity less than 10 μS/cm is preferable, and water with a measured electrical conductivity less than or equal to 1 μS/cm is preferable. In addition, when the water-washing is performed using the aqueous solution other than water, subsequent water-washing may be further performed using water to reduce the amount of impurities contained in the aqueous solution.

### (Solid-Liquid Separation Step)

The solid-liquid separation step is a step for carrying out solid-liquid separation of the slurry to obtain a cake containing the Ni-containing lithium transition metal oxide. A method for the solid-liquid separation is not particularly limited, and the solid-liquid separation is performed by a commonly used apparatus or method. For example, a suction filter, a centrifuge, a filter press, or the like is used. The water content of the cake obtained by the solid-liquid separation is, for example, greater than or equal to 2.0% by mass and less than or equal to 10% by mass.

### (Drying Step)

The drying step is a step for drying the cake containing the Ni-containing lithium transition metal oxide obtained in the solid-liquid separation step. In the drying step, it is preferable to dry the cake containing the Ni-containing lithium transition metal oxide until the water content of the cake becomes less than or equal to 1.0% by mass, for example, from the viewpoint of suppressing deterioration of the battery characteristics when used as a positive electrode active material for a secondary battery. A drying treatment condition is preferably, for example, drying at a temperature greater than or equal to 100° C. and less than or equal to 250° C. in an oxygen atmosphere or a vacuum atmosphere. A drying time is preferably, for example, greater than or equal to 0.5 hours.

The amount of Li remaining on the particle surface of the Ni-containing lithium transition metal oxide in the cake after the drying step is preferably less than or equal to 0.2% by mass with respect to the total mass of the Ni-containing lithium transition metal oxide. When the above amount of Li is set within the above range, for example, the aggregation of secondary particles of the Ni-containing lithium transition metal oxide may be further suppressed as compared with the case outside the above range. In addition, in the subsequent adding step, a sulfonic acid compound is easily dispersed throughout the entire Ni-containing lithium transition metal oxide, and uneven distribution of the sulfonic acid compound can be suppressed. The amount of remaining Li can be calculated, for example, from a titrated amount obtained by carrying out neutralization titration (Balder method) of the slurry containing the Ni-containing lithium transition metal oxide in water or supernatant fluid thereof.

As the lithium compound remaining on the particle surface of the Ni-containing lithium transition metal oxide is removed by the water-wash step, the number of pores on the particle surface of the Ni-containing lithium transition metal oxide and a surface area of particles increase. Therefore, a BET specific surface area of the Ni-containing lithium transition metal oxide in the cake after the drying step is preferably greater than or equal to 0.5 m²/g. When the BET specific surface area is set within the above range, for example, the aggregation of secondary particles of the Ni-containing lithium transition metal oxide may be further suppressed as compared with the case outside the above range. In addition, in the subsequent adding step, a sulfonic acid compound is easily dispersed throughout the entire Ni-containing lithium transition metal oxide, and uneven distribution of the sulfonic acid compound can be suppressed. The BET specific surface area can be measured with a BET method by nitrogen gas adsorption using a specific surface area measuring apparatus (QUANTASORB QS-10 manufactured by GS Yuasa Corporation).

### (Adding Step)

The adding step is a step for adding a sulfonic-acid-compound-containing solution to the cake after the drying step. A method for adding the sulfonic-acid-compound-containing solution to the cake may be any method, and the sulfonic-acid-compound-containing solution may be added to the cake that is being transported on a belt conveyor, for example, when the cake is transported on the belt conveyor. In addition, the sulfonic-acid-compound-containing solution may be added to the cake introduced into a container or the like.

The adding step causes the sulfonic acid compound to adhere to the particle surface of the Ni-containing lithium transition metal oxide. If the sulfonic acid compound is not dispersed but is unevenly dispersed throughout the entire Ni-containing lithium transition metal oxide, the aggregation of secondary particles of the Ni-containing lithium transition metal oxide is promoted, and coarse particles are formed. However, since the sulfonic-acid-compound-containing solution is added to the Ni-containing lithium transition metal oxide in which the aggregation of secondary particles is suppressed in the present embodiment, the sulfonic acid compound is dispersed throughout the entire Ni-containing lithium transition metal oxide, thereby suppressing the formation of coarse particles. Therefore, when the positive electrode active material obtained according to the present embodiment is subjected to a sieving treatment, a sieving loss rate of the positive electrode active material can be reduced. In addition, when a positive electrode is manufactured using the positive electrode active material in which the uneven distribution of the sulfonic acid compound is suppressed, the resistance of the positive electrode can be reduced, and an increase in resistance associated with a battery charge and discharge cycle can also be suppressed.

The sulfonic acid compound in the sulfonic-acid-compound-containing solution is represented by the following general formula (I).

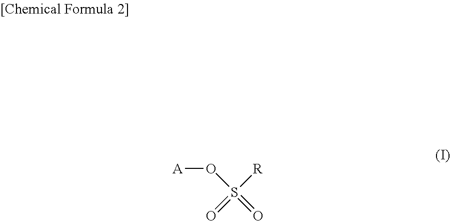

In the formula, A is H, Li, or Na. R is H or a hydrocarbon group. The hydrocarbon group is preferably, for example, a hydrocarbon having 1 to 24 carbon atoms. Examples of the hydrocarbon group include an alkyl group, an alkenyl group, and an aryl group. Examples of the alkyl group include a methyl group, an ethyl group, a propyl group (including n-propyl and iso-propyl), a butyl group (n-butyl, t-butyl, iso-butyl and sec-butyl), and a hexyl group (including branched and linear isomers thereof). Examples of the alkenyl group include a vinyl group, an allyl group, and a hexenyl group (including branched and linear isomers thereof). Examples of the aryl group include a phenyl group, a tolyl group, a xylyl group, a naphthyl group, and a benzyl group.

The sulfonic-acid-compound-containing solution is not particularly limited as long as the sulfonic acid compound is contained, but one obtained by dissolving the sulfonic acid compound in an alkali aqueous solution such as lithium hydroxide or sodium hydroxide is preferable. The concentration of the sulfonic acid compound in the sulfonic-acid-compound-containing solution is, for example, greater than or equal to 0.5 mol/L and less than or equal to 15 mol/L. The pH of the sulfonic-acid-compound-containing solution may be, for example, in the range of 0.1 to 12, and preferably in the range of 7 to 11.

An addition amount of the sulfonic-acid-compound-containing solution is preferably adjusted, for example, such that the ratio of the mass of the sulfonic acid compound in the solution with respect to the mass of the Ni-containing lithium transition metal oxide is greater than or equal to 0.05% by mass. When the addition amount of the sulfonic-acid-compound-containing solution is too small, the coverage of the sulfonic acid compound on the particle surface of the Ni-containing lithium transition metal oxide is low, and the effect of improving the battery characteristics may decrease.

After the adding step, it is preferable to perform a drying step for drying the cake to which the sulfonic-acid-compound-containing solution has been added. A drying condition in the drying step may be the same as that described above. Alternatively, it is preferable to perform a mixing step for mixing the cake and the sulfonic-acid-compound-containing solution after the adding step and a drying step for drying a mixture containing the cake and the sulfonic-acid-compound-containing solution after the mixing step. Here, a method for mixing is not particularly limited, and for example, the cake and the sulfonic-acid-compound-containing solution are stirred, vibrated, or swung to be mixed. A general mixer can be used for mixing the cake and the sulfonic-acid-compound-containing solution. Examples thereof include a shaker mixer, a Redige mixer, a Julia mixer, a V blender, a rotary drum mixer, a container blender, and a Nauta mixer.

The mixing step is preferably performed for 5 minutes or longer. When the mixing step is performed for 5 minutes or longer, for example, the dispersibility of the sulfonic acid compound can be further improved. In addition, drying may be performed after the mixing step. A drying condition in the drying step may be the same as that described above.

In the positive electrode active material obtained by such a manufacturing method, a sieving treatment for removing coarse particles is performed. As a result, the positive electrode active material can be adjusted to a predetermined particle size. Examples of an apparatus used for the sieving treatment include a vibrating sieve and a centrifugal classifier. In addition, the positive electrode active material before the sieving treatment may be crushed by a jet mill, a roll mill, a masscolloider, or the like as necessary. The crushing refers to dispersing or disentangling aggregated particles.

According to the manufacturing method of the present embodiment, as described above, the aggregation of secondary particles of the Ni-containing lithium transition metal oxide is suppressed, and thus the formation of coarse particles is suppressed. Therefore, it is possible to reduce the sieving loss rate of the positive electrode active material when the positive electrode active material obtained by the present manufacturing method is sieved. In addition, since the positive electrode can be manufactured using the positive electrode active material in which the uneven distribution of the sulfonic acid compound is suppressed, the resistance of the positive electrode can be reduced, and the increase in resistance associated with the battery charge and discharge cycle can also be suppressed.

A secondary battery to which the positive electrode active material manufactured by the above-described manufacturing method is applied is obtained, for example, by housing an electrode assembly in which electrodes (a positive electrode and a negative electrode) and a separator are layered or wound together with an electrolyte in a housing such as a battery can or a laminate. Hereinafter, the positive electrode, the negative electrode, the separator, and the electrolyte will be described.

The electrolyte has, for example, ion conductivity (for example, lithium ion conductivity). The electrolyte may be a liquid electrolyte (electrolytic solution) or a solid electrolyte.

The liquid electrolyte (electrolytic solution) contains, for example, a non-aqueous solvent and an electrolyte salt dissolved in the non-aqueous solvent. As the non-aqueous solvent, for example, esters, ethers, nitriles, amides, and mixed solvents of two or more thereof are used. Examples of the non-aqueous solvent include ethylene carbonate (EC), ethyl methyl carbonate (EMC), dimethyl carbonate (DMC), diethyl carbonate (DEC), and mixed solvents thereof. The non-aqueous solvent may contain a halogen-substituted product (for example, fluoroethylene carbonate or the like) in which at least a part of hydrogen in these solvents is substituted with a halogen atom such as fluorine. As the electrolyte salt, for example, a lithium salt such as LiPF₆ is used.

In addition, as the solid electrolyte, for example, a solid or gel polymer electrolyte, an inorganic solid electrolyte, or the like can be used. The polymer electrolyte contains, for example, a lithium salt and a matrix polymer or contains, for example, a non-aqueous solvent, a lithium salt, and a matrix polymer. As the matrix polymer, for example, a polymer material that absorbs a non-aqueous solvent and gelates is used. Examples of the polymer material include a fluororesin, an acrylic resin, and a polyether resin. As the inorganic solid electrolyte, for example, a material (for example, an oxide-based solid electrolyte, a sulfide-based solid electrolyte, a halogen-based solid electrolyte, or the like) known for all-solid-state lithium ion secondary batteries and the like can be used. Note that the electrolyte exemplified above is a non-aqueous electrolyte, but the electrolyte is not limited to the non-aqueous electrolyte, and may be an aqueous electrolyte.

The positive electrode includes a positive electrode current collector and a positive electrode mixture layer formed on the positive electrode current collector. The positive electrode mixture layer is preferably formed on both surfaces of the positive electrode current collector. As the positive electrode current collector, a foil of a metal that is stable in a potential range of the positive electrode, such as aluminum, a film in which the metal is disposed on a surface layer thereof, or the like can be used. The positive electrode mixture layer contains the positive electrode active material manufactured by the above-described manufacturing method. In addition, the positive electrode mixture layer may contain a binding agent, a conductive agent, or the like. The positive electrode can be manufactured, for example, by applying a positive electrode mixture slurry containing the positive electrode active material, the binding agent, the conductive agent, and the like onto the positive electrode current collector, drying a coating film, and then rolling the coating film to form the positive electrode mixture layer on the positive electrode current collector.

Examples of the conductive agent include carbon materials such as carbon black (CB), acetylene black (AB), Ketjenblack, carbon nanotube (CNT), graphene, and graphite. Among them, one type may be used alone, or two or more types may be used in combination.

As the binding agent, a fluorine-based resin such as polytetrafluoroethylene (PTFE) or polyvinylidene fluoride (PVDF), polyacrylonitrile (PAN), a polyimide-based resin, an acryl-based resin, a polyolefin-based resin, carboxymethyl cellulose (CMC) or a salt thereof, polyethylene oxide (PEO), and the like may be used in combination. Among them, one type may be used alone, or two or more types may be used in combination.

The negative electrode includes a negative electrode current collector and a negative electrode mixture layer formed on the negative electrode current collector. The negative electrode mixture layer is preferably formed on both surfaces of the negative electrode current collector. As the negative electrode current collector, a foil of a metal that is stable in a potential range of the negative electrode, such as copper or a copper alloy, a film in which the metal is disposed on a surface layer thereof, or the like can be used. The negative electrode mixture layer contains, for example, a negative electrode active material, a binding agent, and the like. The negative electrode can be manufactured, for example, by applying a negative electrode mixture slurry containing the negative electrode active material, the binding agent, and the like onto the negative electrode current collector, drying a coating film, and then rolling the coating film to form the negative electrode mixture layer on the negative electrode current collector.

The negative electrode active material contained in the negative electrode mixture layer is not particularly limited as long as it is capable of reversibly absorbing and releasing lithium ions, and a carbon-based active material such as graphite is generally used. The graphite may be any of natural graphite, such as scale-like graphite, massive graphite, or earthy graphite, and artificial graphite such as massive artificial graphite or graphitized mesophase carbon microbead. In addition, as the negative electrode active material, a metal alloyed with Li such as Si or Sn, a metal compound containing Si or Sn, a lithium titanium composite oxide, or the like may be used. The negative electrode active material other than the carbon-based active material is preferably a silicon-based active material. Examples of the silicon-based active material include a Si-containing compound represented by SiOₓ (0.5≤x≤1.6), and a Si-containing compound in which Si fine particles are dispersed in a lithium silicate phase represented by Li_{2y}SiO_{(2+y)} (0<y<2), or the like. The amount of the silicon-based active material contained in the negative electrode mixture layer is, for example, preferably greater than or equal to 1% by mass and less than or equal to 15%, and more preferably greater than or equal to 5% by mass and less than or equal to 10% by mass, with respect to the total mass of the negative electrode active material.

Examples of the binding agent contained in the negative electrode mixture layer include materials similar to those for the positive electrode. In addition, the negative electrode mixture layer may contain a conductive agent. Examples of the conductive agent include materials similar to those for the positive electrode.

As the separator, for example, a porous sheet having an ion permeation property and an insulation property is used. Specific examples of the porous sheet include a microporous thin film, a woven fabric, and a nonwoven fabric. As a material of the separator, an olefin-based resin such as polyethylene or polypropylene, cellulose, or the like is suitable. The separator may be a laminate including a cellulose fiber layer and a thermoplastic resin fiber layer formed of an olefin-based resin or the like. In addition, a multilayer separator including a polyethylene layer and a polypropylene layer may be used, and a separator having a surface coated with a material such as an aramid-based resin or a ceramic may be used.

### EXAMPLES

Hereinafter, the present disclosure will be further described with reference to Examples, but the present disclosure is not limited to these Examples.

### Example 1

A slurry obtained by mixing 100 g of a Ni-containing lithium transition metal oxide (LiNi_{0.9}Co_{0.05}Mn_{0.05}O₂), obtained by mixing an oxide containing Ni as a main component with lithium hydroxide and then firing the mixture, and 100 mL of pure water is stirred to perform the water-wash step for 30 minutes.

The slurry after water-washing was subjected to solid-liquid separation to obtain a cake containing the Ni-containing lithium transition metal oxide (the solid-liquid separation step). The obtained cake was heated to 200° C. using a vacuum dryer and dried for 5 hours (the drying step). A sulfonic-acid-compound-containing solution was added to the cake after drying (the adding step). The sulfonic-acid-compound-containing solution was manufactured by adding 50 g of methanesulfonic acid to a LiOH neutralized solution in which 22 g of lithium hydroxide monohydrate was dissolved in 100 g of pure water. In addition, the sulfonic-acid-compound-containing solution was added to the slurry such that the ratio of the mass of a sulfonic acid compound in the sulfonic-acid-compound-containing solution with respect to the mass of the Ni-containing lithium transition metal oxide was 0.75% by mass.

The cake and the sulfonic-acid-compound-containing solution were mixed, and the obtained mixture was dried. A positive electrode active material thus obtained was sieved with a sieve having an opening of 100 μm to remove coarse particles. A sieving loss rate of the positive electrode active material by this sieving treatment was 99%.

### [Manufacture of Positive Electrode]

A positive electrode active material, acetylene black as a conductive agent, and polyvinylidene fluoride as a binding material were mixed at a mass ratio of 98:1:1 to prepare a positive electrode mixture slurry having a solid content of 70%. The slurry was applied over both surfaces of an aluminum foil having a thickness of 15 μm, a coating film was dried, and then the coating film was rolled by a rolling roller, thereby manufacturing a positive electrode in which a positive electrode active material layer was formed on both surfaces of a positive electrode current collector.

### [Manufacture of Negative Electrode]

A graphite powder as a negative electrode active material, carboxymethyl cellulose (CMC) as a binding material, and styrene butadiene rubber (SBR) were mixed at a mass ratio of 98:1:1, and an appropriate amount of water was added to this mixture, thereby preparing a negative electrode mixture slurry. The slurry was applied onto both surfaces of a copper foil having a thickness of 8 μm, a coating film was dried, and then the coating film was rolled by a rolling roller, thereby manufacturing a negative electrode in which a negative electrode active material layer was formed on both surfaces of a negative electrode current collector.

### [Preparation of Non-Aqueous Electrolyte]

5 parts by mass of vinylene carbonate (VC) was added to 100 parts by mass (EC:DMC=1:3 by volume) of a mixed solvent formed of ethylene carbonate (EC) and dimethyl carbonate (DMC), and LiPF₆ was dissolved at a concentration of 1 mol/L, thereby preparing a non-aqueous electrolyte.

### [Manufacture of Non-Aqueous Electrolyte Secondary Battery]

A lead was attached to each of the positive electrode and the negative electrode, and the positive electrode and the negative electrode were wound with a separator interposed therebetween, thereby manufacturing a wound electrode assembly. The electrode assembly was inserted into a case body, and the negative electrode lead was welded to a bottom surface of the case body. Next, the positive electrode lead was welded to a sealing assembly. Then, after the non-aqueous electrolyte was injected into the case body, an open end of the case body was sealed with the sealing assembly via a gasket, thereby manufacturing a non-aqueous electrolyte secondary battery.

### Example 2

A positive electrode active material was manufactured in the same manner as in Example 1 except that a diluted solution diluted by adding 100 g of pure water to 50 g of methanesulfonic acid was used as a sulfonic-acid-compound-containing solution. When the obtained positive electrode active material was sieved in the same manner as in Example 1, a sieving loss rate of the positive electrode active material was 99%. This positive electrode active material was used to produce a non-aqueous electrolyte secondary battery in the same manner as in Example 1.

### Example 3

A positive electrode active material was manufactured in the same manner as in Example 1 except that a solution obtained by adding 100 g of pure water to 50 g of lithium methanesulfonate and dissolving the mixture was used as a sulfonic-acid-compound-containing solution. When the obtained positive electrode active material was sieved in the same manner as in Example 1, a sieving loss rate of the positive electrode active material was 99%. This positive electrode active material was used to produce a non-aqueous electrolyte secondary battery in the same manner as in Example 1.

### Example 4

A positive electrode active material was manufactured in the same manner as in Example 1 except that LiNi_{0.9}Co_{0.05}Al_{0.05}O₂ was used as a Ni-containing lithium transition metal oxide obtained by mixing an oxide containing Ni as a main component with lithium hydroxide and then firing the mixture. When the obtained positive electrode active material was sieved in the same manner as in Example 1, a sieving loss rate of the positive electrode active material was 99%. This positive electrode active material was used to produce a non-aqueous electrolyte secondary battery in the same manner as in Example 1.

### Example 5

A positive electrode active material was manufactured in the same manner as in Example 2 except that LiNi_{0.9}Co_{0.05}Al_{0.05}O₂ was used as a Ni-containing lithium transition metal oxide obtained by mixing an oxide containing Ni as a main component with lithium hydroxide and then firing the mixture. When the obtained positive electrode active material was sieved in the same manner as in Example 1, a sieving loss rate of the positive electrode active material was 99%. This positive electrode active material was used to produce a non-aqueous electrolyte secondary battery in the same manner as in Example 1.

### Example 6

A positive electrode active material was manufactured in the same manner as in Example 3 except that LiNi_{0.9}Co_{0.05}Al_{0.05}O₂ was used as a Ni-containing lithium transition metal oxide obtained by mixing an oxide containing Ni as a main component with lithium hydroxide and then firing the mixture. When the obtained positive electrode active material was sieved in the same manner as in Example 1, a sieving loss rate of the positive electrode active material was 99%. This positive electrode active material was used to produce a non-aqueous electrolyte secondary battery in the same manner as in Example 1.

### Comparative Example 1

A sulfonic-acid-compound-containing solution was added to a Ni-containing lithium transition metal oxide (LiNi_{0.9}Co_{0.05}Mn_{0.05}O₂) obtained by mixing an oxide containing Ni as a main component with lithium hydroxide and then firing the mixture. When a positive electrode active material thus obtained was sieved in the same manner as in Example 1, a sieving loss rate of the positive electrode active material was 96%. This positive electrode active material was used to produce a non-aqueous electrolyte secondary battery in the same manner as in Example 1.

### Comparative Example 2

A positive electrode active material was obtained in the same manner as in Example 1 except that the adding step for adding a sulfonic-acid-compound-containing solution to a cake after the drying step was not performed. When the obtained positive electrode active material was sieved in the same manner as in Example 1, a sieving loss rate of the positive electrode active material was 99%. This positive electrode active material was used to produce a non-aqueous electrolyte secondary battery in the same manner as in Example 1.

### [Resistance Increase Rate]

The non-aqueous electrolyte secondary battery of each of Examples and each of Comparative Examples was charged to SOC 50% at a constant current of 0.5 C under a temperature environment of 25° C. The voltage at this time was defined as VO. Next, discharge was performed at a constant current of 0.5 C for 10 seconds. The voltage at this time was defined as Vi. Then, direct current resistance (DCR) was obtained from the following formula. This is defined as the initial direct current resistance.

$$DCR = ( V 0 - V 1 ) / 0.5 It$$

Next, the non-aqueous electrolyte secondary battery of each of Examples and each of Comparative Examples was charged at a constant current of 0.5 C under a temperature environment of 25° C. until the battery voltage reached 4.2 V, and then discharged at a constant current of 0.5 C until the battery voltage reached 2.5 V The charge and discharge was defined as one cycle, and 100 cycles were performed. Then, the direct current resistance was determined in the same manner as described above for the non-aqueous electrolyte secondary battery of each of Examples and each of Comparative Examples after the 100 cycles of charge and discharge. This is defined as the direct current resistance after the charge and discharge cycle.

The initial direct current resistance and the direct current resistance after the charge and discharge cycle were applied to the following formula to determine a resistance increase rate.

$$Resistance increase rate = ( Direct current resistance after charge and discharge cycle / Initial direct current resistance ) \times 100$$

Results of the sieving loss rates and the resistance increase rates of the positive electrode active materials of Examples and Comparative Examples are summarized in Table 1. Regarding the resistance increase rate in Table 1, a value of Comparative Example 1 was used as a reference (1.00), and relative values were described for the other Examples and Comparative Example.

TABLE 1

| | | | | | | | | Water- | | |
|---|---|---|---|---|---|---|---|---|---|---|
| | Ni-containing | | | | | | | wash step | | |
| | lithium transition | | | | Sulfonic-acid-compound-containing | | | Solid- | | |
| | metal oxide | | | | solution | | | liquid | | |
| | Transition metal | | | | | | Addition | separation | Evaluation | |
| | ratio | | | | | | amount | step | Sieving | Resistance |
| | (mol %) | | | | Sulfonic acid | | (% by | Drying | loss | increase |
| | Ni | Co | Al | Mn | compound | Solution | mass) | step | rate | rate |
| Example 1 | 90 | 5 | 0 | 5 | Methanesulfonic | LiOH | 0.75 | Presence | 99% | 0.66 |
| | | | | | acid | neutralized | | | | |
| | | | | | | solution | | | | |
| Example 2 | 90 | 5 | 0 | 5 | Methanesulfonic | Diluted | 0.75 | Presence | 99% | 0.66 |
| | | | | | acid | solution | | | | |
| Example 3 | 90 | 5 | 0 | 5 | Li | Diluted | 0.75 | Presence | 99% | 0.60 |
| | | | | | methanesulfonate | solution | | | | |
| Example 4 | 90 | 5 | 5 | 0 | Methanesulfonic | LiOH | 0.75 | Presence | 99% | 0.70 |
| | | | | | acid | neutralized | | | | |
| | | | | | | solution | | | | |
| Example 5 | 90 | 5 | 5 | 0 | Methanesulfonic | Diluted | 0.75 | Presence | 99% | 0.57 |
| | | | | | acid | solution | | | | |
| Example 6 | 90 | 5 | 5 | 0 | Li | Diluted | 0.75 | Presence | 99% | 0.59 |
| | | | | | methanesulfonate | solution | | | | |
| Comparative | 90 | 5 | 0 | 5 | Methanesulfonic | Diluted | 0.75 | Absence | 96% | 1.00 |
| Example 1 | | | | | acid | solution | | | | |
| Comparative | 90 | 5 | 0 | 5 | — | — | — | Presence | 99% | 0.88 |
| Example 2 | | | | | | | | | | |

The sieving loss rates of the positive electrode active materials in Examples 1 to 6 were values lower than that in Comparative Example 1. From this, it can be said that the sieving loss rate of the positive electrode active material can be reduced by adding the sulfonic-acid-compound-containing solution to the cake containing the Ni-containing lithium transition metal oxide obtained through the water-wash step, the solid-liquid separation step, and the drying step.

In addition, the resistance increase rate in Comparative Example 1 was higher than that in Comparative Example 2, whereas the resistance increase rates in Examples 1 to 6 were lower than that in Comparative Example 2. From this, it can be said that the positive electrode active material capable of suppressing an increase in resistance of the battery can be obtained by adding the sulfonic-acid-compound-containing solution to the cake containing the Ni-containing lithium transition metal oxide obtained through the water-wash step, the solid-liquid separation step, and the drying step.

1. A method for manufacturing a positive electrode active material for a secondary battery, the method comprising:
a water-wash step for stirring a slurry obtained by mixing an Ni-containing lithium transition metal oxide with water or an aqueous solution and water-washing the Ni-containing lithium transition metal oxide;
a solid-liquid separation step for carrying out solid-liquid separation of the slurry to obtain a cake containing the Ni-containing lithium transition metal oxide;
a drying step for drying the cake; and
an adding step for adding a sulfonic-acid-compound-containing solution to the cake after the drying step,
wherein the sulfonic acid compound is expressed by general formula (I) 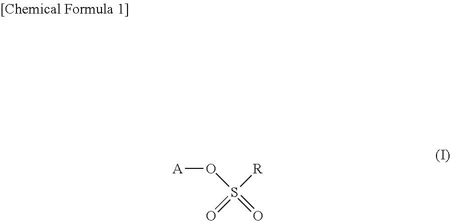
where A is H, Li, or Na, and R is H or a hydrocarbon group.

2. The method for manufacturing a positive electrode active material for a secondary battery according to claim 1, wherein an amount of Li remaining on a particle surface of the Ni-containing lithium transition metal oxide in the cake after the drying step is less than or equal to 0.2% by mass with respect to a total amount of the Ni-containing lithium transition metal oxide.

3. The method for manufacturing a positive electrode active material for a secondary battery according to claim 1, wherein a BET specific surface area of the Ni-containing lithium transition metal oxide in the cake after the drying step is greater than or equal to 0.5 m²/g.

4. The method for manufacturing a positive electrode active material for a secondary battery according to claim 1, further comprising a drying step for drying the cake after the adding step.

5. The method for manufacturing a positive electrode active material for a secondary battery according to claim 1, further comprising:
a mixing step for mixing the cake and the sulfonic-acid-compound-containing solution after the adding step; and
a drying step for drying the cake after the mixing step.
